(19) United States
(12) Patent Application Publication
(10) Pub. No.: US 2025/0156266 A1
(43) Pub. Date: May 15, 2025

(54) DEVICE AND METHOD FOR MONITORING A DATA PROCESSING UNIT

(71) Applicant: RAFI GmbH & Co. KG, Berg (DE)

(72) Inventors: Frank Fleischer, Bergatreute (DE); Sebastian Rathje, Günzburg (DE); Benjamin Ummenhofer, Ostrach (DE); Christian Gehweiler, Baindt (DE)

(21) Appl. No.: 18/941,110

(22) Filed: Nov. 8, 2024

(30) Foreign Application Priority Data
Nov. 11, 2023 (EP) 23209280.9

(51) Int. Cl. G06F 11/07

(52) U.S. Cl. CPC G06F 11/0793; G06F 11/0736; G06F 11/079

(57) ABSTRACT

On account of their reasonable costs and versatility, conventional processing units are frequently used for a wide variety of tasks. However, if these tasks are also safety-critical, it is necessary to check the operation of the processing units. This concerns in particular the monitor output of the processing unit, but not just for touchscreen applications. If an error results in representation of an incorrect image on the monitor and a faulty command is thus input via the touchscreen, this may lead to safety-critical situations. For this purpose, known systems use so-called watchdogs, which cyclically test the processing unit but not the monitor output. Additional testing of the monitor is known, but complicated.

The invention therefore provides that a sequence of colored test signals is continuously output on an evaluation area of the monitor; this system is also known as an evaluation unit. The evaluation unit continuously checks this sequence and reports when there is a deviation from the sequence, or then restarts the processing unit. Since, due to the test signal sequence being known on both sides, it is not necessary to coordinate the evaluation unit with the processing unit, such a check may take place in a much easier and more cost-effective manner. In addition, due to the use of a color sensor, each individual color channel may also be tested.

### REFERENCE TO PENDING PRIOR PATENT APPLICATION

This patent application claims benefit of European Patent Application No. 23209280.9, filed Nov. 11, 2023, which patent application is hereby incorporated herein by reference.

### FIELD OF THE INVENTION

The present invention relates to a device for monitoring a data processing unit that is made up at least of a processing unit and a monitor connected thereto, and including an evaluation unit that is in data connection with at least one optical sensor, the at least one optical sensor for detecting test signals being associated with an evaluation area of the monitor. The present invention further relates to such a method.

### BACKGROUND OF THE INVENTION

Such a device and such a method are already known from DE 102 29 342 A1, which describes that the processing unit, to be checked, regularly outputs signals for testing by an optical sensor. However, this is not easily transferable to a conventional data processing unit, since transfer errors may occur, for example errors in the transfer between the processing unit and its monitor. However, DE 102 29 342 A1 teaches only the checking of the otherwise securely transferred data.

In this context, for example a personal computer that operates with embedded Linux, for example, as the operating system is understood as a conventional data processing unit. However, the same applies for other operating systems. Such data processing units are reasonably priced and widely used, and operate using known, proven interfaces. In addition, graphics frameworks such as Qt, for example, are used.

Since these software components generally do not meet the requirements for functional security, additional measures must be taken to ensure that the correct image data have been output, and in particular also that the software components that are used function without error. Thus, as stated in the above-mentioned publication, a so-called watchdog is used to check the computer, whose signals that are sent to the monitor must be read out and compared to the signals that are actually output. This involves a high level of complexity with regard to the multiple components that are required.

Known watchdogs require that they be triggered at regular intervals by the data processing unit to be monitored. After a certain period of time, if the watchdog receives no status signal from the data processing unit or receives the signal too early, the watchdog assumes that the computer is no longer functioning in an error-free manner. Depending on the setting, a response may be made in the form of an error message or also a direct initiation of measures, all the way to shutting down or restarting the data processing unit.

Furthermore, there is the problem that a representation on the monitor may be severely impaired even by the failure of individual color channels. If a representation of a piece of information is depicted in the color red, for example, and a defect in the red data line occurs in a data line between the processing unit and the monitor, the required information may no longer be represented, or may not be represented clearly enough, on the monitor. For warning messages, which are frequently represented in the color red, this may result in a safety-relevant error. However, for a strictly black-and-white test, which cannot take notice of color errors, such an error is not recognized.

### SUMMARY OF THE INVENTION

Against this background, the object underlying the present invention is to provide a device and a method for monitoring a data processing unit, in which monitoring of the computer and its data transfer as well as monitoring of the correct monitor output take place using only one component, which also encompasses checking of the correct color representation.

This object is achieved by a device for monitoring a data processing unit according to the features of independent claim 1, and by a corresponding method according to the features of independent claim 9. Meaningful embodiments of the device and also of the method may be inferred in each case from the respective dependent claims.

In this regard, a device is proposed for monitoring a data processing unit that is made up at least of a processing unit and a monitor connected thereto, and including an evaluation unit that is in data connection with at least one optical sensor, the at least one optical sensor for detecting test signals being associated with an evaluation area of the monitor. According to the invention, the device is characterized in that software with a monitor output runs on the processing unit, and includes the continuous output of a temporal sequence of colored test signals on the evaluation area of the monitor, wherein a timer is associated with the evaluation unit, and based on the time signal of the timer a frequency of the test signals may be checked by the evaluation unit, and wherein the at least one optical sensor is at least one color sensor, and based on the signals of the color sensor, the coloring of the test signals may be checked by the evaluation unit.

With regard to the method, the invention is characterized in that software with a monitor output runs on the processing unit, and outputs a stored continuous sequence of colored test signals on the evaluation area of the monitor, and the at least one optical sensor detects the test signals according to their coloring, and the evaluation unit, by use of a timer, checks the compliance of the continuous sequence of colored test signals, identically stored in the evaluation unit, according to their coloring, order, and point in time.

Thus, in a defined evaluation area the processing unit continuously outputs a test signal that is detected by an optical sensor and relayed to the evaluation unit. The test signal may in particular be a sequence of colored signals that are output at certain points in time, so that an error may be inferred even by a deviation in the order of the colors. On a monitor, the evaluation area may have a size of 5×5 millimeters, for example, which may be completely filled in with a color. One possible sequence is red-green-blue, with a color change every 100 milliseconds, with continuous repetition of this sequence. If no red signal can be identified after the phase with a blue signal within the indicated time frame, this may be attributed to a defect in the color line; however, if no other color then follows, a system crash of the processing unit may be present. If the monitor display changes to black in the evaluation area, this may indicate a failure of the signal line or of the processing unit, or of its components such as the graphics card. In contrast, a change that is too slow or too fast indicates an error in the program flow or the operating system.

However, all of these cases may be detected by the device according to the invention or by use of the method according to the invention. Overall, the invention operates with the assumption that if the expected display is correctly represented in the evaluation area, then the other areas of the monitor are likewise functioning correctly. In contrast, a failure of subareas of the monitor may be detected using the method according to the invention only when this failure pertains to the subarea containing the evaluation area.

In one specific embodiment, it may be provided that a memory is associated with the evaluation unit, and a sequence of reference signals for comparison to the detected test signals of the at least one optical sensor according to brightness, color, and point in time is stored in the memory. This is the identical signal sequence that is generated by the software that runs on the processing unit and generates the signals on the monitor. At the beginning of a test, it is necessary only to carry out a synchronization between the signals represented on the monitor and the expected signals, using a conventional process; however, no further deviations are then allowed to occur.

It may preferably be provided that multiple optical sensors that are combined into an array are associated with the evaluation area of the monitor, wherein the evaluation area of the monitor is preferably divided into multiple subareas, and a subarea of the evaluation area is associated with each optical sensor of the array. The greater the number of different signals that are tapped using further sensors, the more reliable is the statement that the monitor is functioning at a certain point in time.

Furthermore, in one specific structural embodiment it may be provided that the at least one optical sensor is placed on the evaluation area of the monitor, wherein a cover layer for masking the optical sensor is preferably applied to the at least one optical sensor, preferably by printing. On the one hand, the sensor requires an undistorted view of the evaluation area, so that installation of the sensor directly above the evaluation area represents a suitable approach. On the other hand, the sensor can then be seen, which for an otherwise black monitor display may interfere with the desired image data. By masking the sensor with a cover layer, it can be ensured that the observer of the device according to the invention cannot see anything, or at the least can see only the inconspicuous cover layer. Besides printing the area, it is also possible to use adhesive bonding, vapor deposition, or some other interposition of the cover layer. This may take place on a rear side of the sensor, optionally on the circuit board thereof, or also on the bottom side of the front glass situated above the monitor.

In addition, the cover layer may include a monitor edge that circumferentially surrounds the monitor, and that overlaps the monitor at least in the region of the least one optical sensor. As a result of a portion of the monitor remaining concealed beneath a monitor edge, although it is not available for display, the evaluation area may be situated in this region of the evaluation area and concealed by the complete monitor edge, provided that this is acceptable. This also allows a much larger evaluation area, or even multiple evaluation areas.

In an alternative embodiment, it may also be meaningful for the at least one optical sensor to be situated next to the monitor, and to be associated with the evaluation area of the monitor by connecting at least one light guiding element in between. The observer thus has full view of the monitor, and the light guiding element brings the light of the evaluation area to the optical sensor situated farther away. The user can thus see the evaluation area. However, if this area is still to be made inconspicuous, the test signals may in each case be output so briefly that the observer has little or no awareness of them.

In particular, it may be provided that the monitor is overlaid by a touch sensor that is mounted on the monitor with a transparent adhesive layer in between, the optical sensor being situated in the plane of the transparent adhesive layer, above the evaluation area of the monitor. The sensor and the evaluation area are thus integrated seamlessly not only on a display itself, but also into a control element in which a correct display is particularly important, and the correct inscription of the touch elements at the time must be ensured.

For a response of the evaluation unit to a determined error, it may initially be provided that means for resetting the processing unit to an initial state are associated with the evaluation unit. A reset of the processing unit thus takes place, so that in the event of a system crash, in many cases the problem may be eliminated. Alternatively, it is easily possible for only an error message to be sent to the evaluation unit or to the processing unit, which may be carried out by optical, acoustic, or functional means by blocking the functions in question, so that a secure state of the overall system may be established.

The above-described invention is explained in greater detail below with reference to one exemplary embodiment.

### BRIEF DESCRIPTION OF THE DRAWINGS

### In the Figures:

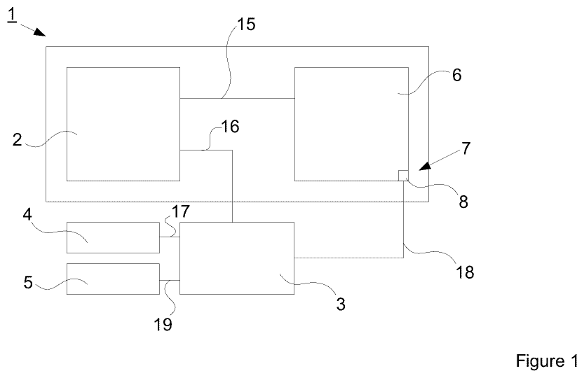

FIG. 1 shows a data processing unit with an evaluation unit in a schematic functional diagram,

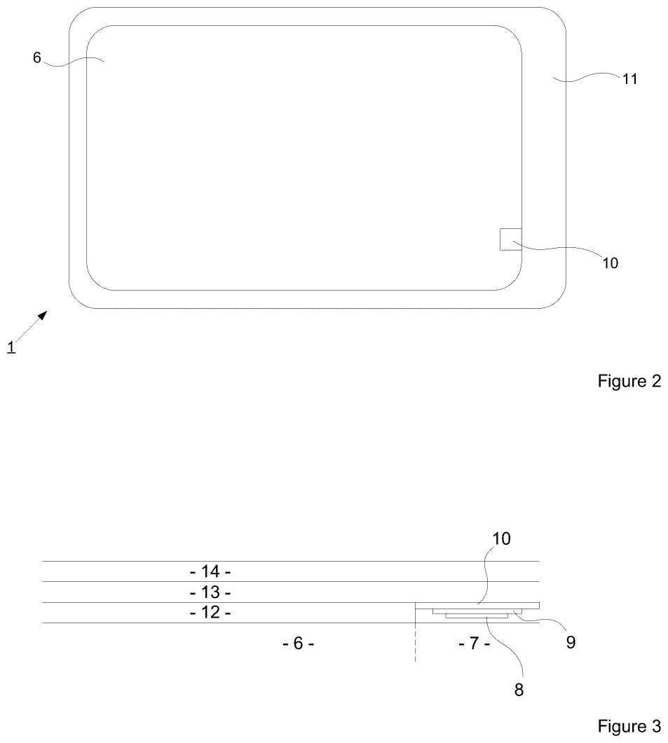

FIG. 2 shows a representation of a monitor in a schematic front view, and

FIG. 3 shows a layer model of the monitor in a lateral cross-sectional illustration.

### DETAILED DESCRIPTION OF THE PREFERRED EMBODIMENTS

FIG. 1 shows a data processing unit 1 made up essentially of a processing unit 2 and a monitor 6 which are in data connection with one another in such a way that the monitor 6 outputs image signals 15 that are generated by the processing unit 2. This may be a touchscreen on a vehicle that implements control elements of the vehicle. Possible commands are pre-formulated for input, and are carried out upon touching the monitor 6 designed as a touchscreen. In particular during operation of the vehicle, it is important that the representation on the monitor 6 is correct and that the user is not looking at outdated data, as a result of which the user could possibly enter incorrect commands if the system of the processing unit 2 is using a different representation than that visible to the user. So-called embedded systems, for example embedded Linux, are preferably used as a processing unit 2, although these do not represent a secure system. There is no check per se that the data represented by the processing unit 2 are in fact also correctly output on the monitor 6. The invention provides such a check.

This takes place using an evaluation unit 3 which interacts with the data processing unit 1 at various interfaces. First, it is provided that the image signals 15 that are transmitted by the processing unit 2 to the monitor 6 output a test signal 18 within an evaluation area 7, which may consist, for example, in filling the evaluation area 7 with color over its entire surface at a certain point in time and preferably for a certain time period. Such a test signal 18 is continuously output, so that the evaluation unit 3 is able to continuously check whether the processing unit 2 as well as the monitor 6 and its image signals 15 are still operational.

Such a check requires that the evaluation unit 3 be connected to at least one optical sensor 8, which in the embodiment illustrated here is mounted directly on the monitor 6 in the evaluation area 7 of the monitor 6. The evaluation area 7 of the monitor 6 is approximately at least 5×5 mm in size, and is advantageously situated at the edge of the monitor. This is also illustrated in FIG. 2, where the evaluation area 7 is provided in the lower right corner of the monitor 6. It is also apparent that the evaluation area 7 is provided with a cover layer 10 in the form of dark printing, so that the optical sensor 8 beneath the cover layer 10 cannot be seen from the outside. The evaluation area 7 together with the superposed optical sensor 8 could also be situated below a continuous monitor edge 11 situated directly below a front glass 14, thus requiring no separate cover.

The test signal 18 applied in the evaluation area 7 includes a stored sequence, for example a full-surface output in red, then after a pause if needed, green, and lastly blue. Only the evaluation area 7 is affected by the full-surface representation; in addition, the output may be so brief that it is barely perceivable. By use of the optical sensor 8 situated above the evaluation area 7, the test signal 18 is optically detected and transmitted as a measured value to the evaluation unit 3. The evaluation unit 3 has a memory 5 in which the identical test signal 18 is stored as a reference signal 19, which is also used by the software of the processing unit 2. By comparing the measured test signals 18 to the reference signals 19 kept in the memory 5, it may be determined whether the test signals 18 are still being properly output. If no difference can be identified in the comparison, it is assumed that in addition to the evaluation area 7 the remaining monitor 6 is also operating properly, since the processing unit 2 always transfers the complete image data for the entire monitor content.

The test signals 18 are evaluated at least with regard to the color values, the point in time that a test signal 18 occurs, and also the brightness if necessary. As a result of the test signals 18 running through different colors in succession, it can be determined whether individual color channels of the monitor are correctly activated. By testing the brightness it is also possible to ensure the correct functioning of the backlight from the monitor 6. If the output of a test signal 18 occurs in an incorrect color, it may be concluded that a defect is present, at least at the color channel in question. On this basis, it is particularly helpful for the test signals to activate either only one of the color channels in each case, or all color channels, wherein an independent evaluation of the test signals 18 still takes place for each color channel. If the evaluation unit 3 waits too long for a new test signal 18, or if a test signal arrives too early or for a certain time period does not arrive at all, this may indicate a system crash or an interruption in the connection of the processing unit 2 to the monitor 6, an error in the graphics unit, and other errors. The correct time is determined by a timer 4, which applies a time signal 17 to the evaluation unit 3.

Lastly, if the evaluation unit 3 determines that the output on the monitor 6 is no longer taking place correctly, it may output an alarm signal. If a direct intervention is also desired, for example a reset signal 16 may be output which restarts the processing unit.

FIG. 3 shows a schematic cross section of the monitor 6 and the layers situated above it, provided that the monitor 6 is a touchscreen device according to the invention. The optical sensor 8, which views the evaluation area 7 of the monitor 6, is situated above the actual monitor 6, which in an edge region forms the described evaluation area 7. This arrangement is situated between the monitor 6 and a touch sensor 13, in particular in the plane of a transparent transmitting adhesive layer 12 situated in between, or a plane of an air gap between the monitor 6 and the touchscreen sensor. Due to the cover layer 10, from the outside it is not possible to perceive the optical sensor through the front glass 14, which is mounted last. The checking of the functional capability of the data processing unit 1 may thus take place continuously, unnoticed by a user.

Thus, a device and a method for monitoring a data processing unit are described above, in which monitoring of the computer and its data transfer as well as monitoring of the correct monitor output takes place using only one component, which also encompasses checking of the correct color representation

### LIST OF REFERENCE NUMBERS

1 data processing unit
2 processing unit
3 evaluation unit
4 timer
5 memory
6 monitor
7 evaluation area
8 optical sensor
10 cover layer
11 monitor edge
12 transparent adhesive layer or air gap
13 touch sensor
14 front glass
15 image signal
16 reset signal
17 time signal
18 test signal
19 reference signal

What is claimed is:

1. A device for monitoring a data processing unit (1) that is made up at least of a processing unit (2) and a monitor (6) connected thereto, and including an evaluation unit (3) that is in data connection with at least one optical sensor (8), the at least one optical sensor (8) for detecting test signals (18) being associated with an evaluation area (7) of the monitor (6), characterized in that software with a monitor output runs on the processing unit (2), and includes the continuous output of a temporal sequence of colored test signals (18) on the evaluation area (7) of the monitor (6), wherein a timer (4) is associated with the evaluation unit (3), and based on the time signal (17) of the timer a frequency of the test signals (18) and preferably their brightness may be checked by the evaluation unit (3), and a memory (5) is associated with the evaluation unit (3), and wherein the at least one optical sensor (8) is at least one color sensor, based on the signals of which the coloring of the test signals (18) may be checked by the evaluation unit (3), and associated with the evaluation unit (3) is a memory (5) in which a sequence of reference signals (19) for comparison to the detected test signals (18) of the at least one optical sensor (8) according to brightness, color, and point in time is stored.

2. The device according to claim 1, characterized in that multiple optical sensors (8) that are combined into an array are associated with the evaluation area (7) of the monitor (6), wherein the evaluation area (7) of the monitor (6) is preferably divided into multiple subareas, and a subarea of the evaluation area (7) is associated with each optical sensor (8) of the array.

3. The device according to claim 1, characterized in that the at least one optical sensor (8) is placed on the evaluation area (7) of the monitor (6), wherein a cover layer (10) for masking the optical sensor (8) is preferably applied to the at least one optical sensor (8), preferably by printing.

4. The device according to claim 3, characterized in that the cover layer (10) includes a monitor edge (11) that circumferentially surrounds the monitor (6), and that overlaps the monitor (6) at least in the region of the least one optical sensor (8).

5. The device according to claim 1, characterized in that the at least one optical sensor (8) is situated next to the monitor (6), and is associated with the evaluation area (7) of the monitor (6) by connecting at least one light guiding element in between.

6. The device according to claim 1, characterized in that the monitor (6) is overlaid by a touch sensor (13) that is mounted on the monitor (6) with a transparent adhesive layer (12) in between, the optical sensor (8) being situated in the plane of the transparent adhesive layer or of the air gap (12), above the evaluation area (7) of the monitor (6).

7. The device according to claim 1, characterized in that means for resetting the processing unit (2) to an initial state or a secure state are associated with the evaluation unit (3).

8. A method for monitoring a data processing unit (1) that is made up at least of a processing unit (2) and a monitor (6) connected thereto, wherein at least one optical sensor (8) that monitors an evaluation area (7) of the monitor (6) that is detected by the at least one optical sensor (8) and transmits detected test signals (18) to an evaluation unit (3) is associated with the monitor (6), characterized in that software with a monitor output runs on the processing unit (2), and outputs a stored continuous sequence of colored test signals (18) on the evaluation area (7) of the monitor (6), and the at least one optical sensor (8) detects the test signals (18) according to their coloring, and the evaluation unit (3), by use of a timer (4), checks the compliance of the continuous sequence of colored test signals (18), identically stored in the evaluation unit (3), according to their coloring, order, and point in time.

9. The method according to claim 8, characterized in that the at least one optical sensor (8) detects the brightness of the test signals (18), and the evaluation unit (3) additionally checks the brightness value of the test signals (18).

10. The method according to claim 8, characterized in that the evaluation unit (3) carries out the check by comparing the detected test signals (18) to a reference signal sequence (19) that is stored in a memory (5) associated with the evaluation unit (3).

11. The method according to claim 8, characterized in that the evaluation unit (3) resets the processing unit (2) or places it in a secure state when the evaluation unit identifies a deviation of the test signals (18) from the reference signal sequence (19) within the scope of the check.
